(19) United States
(12) Patent Application Publication
(10) Pub. No.: US 2026/0274680 A1
(43) Pub. Date: Sep. 17, 2026

(54) LOW-WASTE PROCESS FOR PURIFICATION OF RECYCLED AND NATURAL GRAPHITE

(71) Applicants: Mexichem Fluor, Inc., St. Gabriel, LA (US); Ascend Elements, Inc., Westborough, MA (US)

(72) Inventors: Rakan Ashour, St. Gabriel, LA (US); Karthik Venkataraman, St. Gabriel, LA (US); Suresh Sriramulu, St. Gabriel, LA (US)

(21) Appl. No.: 19/081,762

(22) Filed: Mar. 17, 2025

(51) Int. Cl. C01B 32/215; H01M 10/54

(52) U.S. Cl. CPC C01B 32/215; C01P 2006/40; C01P 2006/80; H01M 10/54

(57) ABSTRACT

A process for purifying graphite while minimizing chemical waste. The first step involves a reaction with an alkaline solution (e.g., NaOH) under pressure to remove insoluble oxides such as silica (SiO₂) and alumina (Al₂O₃). The second step involves a leaching reaction with an acid bath to further remove impurities. Each step results in a treated graphite and a filtrate. The filtrate is recovered and regenerated with deionized water or minimal amount of fresh alkali or acid, and repeatedly reused for the purification until the solubility limit of one of the impurities is reached, or the kinetics of the reaction becomes prohibitively slow.

### BACKGROUND

Graphite is a critical component in lithium-ion batteries, where it serves as the primary anode material. Despite the availability of various cathode materials that can enhance battery performance in terms of energy and power density, graphite remains the preferred choice for anodes due to its superior electrochemical properties. Currently, there are no commercially viable alternatives that match the performance characteristics of graphite for this application. As a result, the demand for graphite is projected to increase significantly in the coming years.

Lithium-ion cells typically comprise approximately 20% graphite, and the growing demand for electric vehicles (EVs) is expected to further drive the need for this material. However, the supply of high-quality graphite has not kept pace with this surge in demand, leading to potential market shortages. For graphite to be used as an anode material, it needs to meet stringent purity standards, typically >99.9%. Addressing the challenges in purifying graphite to such stringent standards is crucial to ensuring a stable supply chain for the expanding battery market.

### SUMMARY

Disclosed herein is a process for purification of graphite to purity >99.95% while minimizing chemical waste. The process is a two-step purification reaction that effectively purifies graphite with a wide range of impurities. The first step involves a reaction with an aqueous alkaline solution (e.g., NaOH) under pressure to remove insoluble oxides such as silica (SiO₂) and alumina (Al₂O₃). The second step involves a leaching reaction with an acid bath to further remove impurities. After each reaction, the graphite is separated from the alkaline or acid solution (e.g., through filtration), resulting in a treated graphite and a filtrate. The alkaline filtrate is recovered and regenerated with DI water or minimal amount of fresh alkali, and repeatedly reused for the purification until the solubility limit of either NaAlO₂ or Na₂SiO₃ is reached, or the kinetics of the reaction becomes prohibitively slow. Similarly, the acid filtrate is recovered and regenerated with DI water or minimal amount of fresh acid, and repeatedly reused for the purification until the free acid concentration drops and the kinetics of the leaching reaction becomes prohibitively slow.

Therefore, disclosed and claimed herein is a method of producing purified graphite, the method comprising:
(a) treating a graphite material with an alkaline solution under an elevated temperature and pressure to yield an alkaline treated graphite and an alkaline filtrate; and
(b) treating the alkaline treated graphite with an acid solution to yield a purified graphite and an acid filtrate;
wherein the alkaline filtrate is recovered by adding DI water and then reused in step (a), and the acid filtrate is recovered by adding DI water and then reused in step (b).

The method can be used to purify various sources of graphite materials, including, but not limited to, natural graphite, spheronized graphite, or graphite from recycled battery materials.

In step (a), the aqueous alkaline solution may comprise one or more alkali selected from the group consisting of NaOH, KOH, LiOH, and NH₄OH. Preferably, the alkaline solution is an aqueous solution of NaOH. The temperature of the reaction is preferably from about 100 to about 250° C., and the pressure is preferably from more than 1 to about 20 bar. In one exemplary reaction condition, the treatment is conducted under a temperature of 200° C. and a pressure of 10 bar.

The method may further comprise washing the alkaline-treated graphite with DI water after step (a) and using the resulting wash solution to recover the alkaline filtrate.

The recovered alkaline filtrate is reused until the recovered alkaline filtrate comprises lower than 10% alkali by weight and higher than 10% NaAlO₂ by weight. The method further comprises bleeding a portion of the recovered alkaline filtrate that comprises lower than 10% alkali by weight or higher than 10% NaAlO₂ by weight, and adding an amount of fresh alkali to obtain a regenerated alkaline filtrate that comprises at least 10% alkali by weight and no more than 10% NaAlO₂ by weight for reuse in step (a).

In step (b), the acid solution may comprise one or more acids selected from the group consisting of HCl, HNO₃, H₂SO₄, and HF. Preferably, the acid solution is an aqueous solution of HCl. Preferably, the reaction is conducted at a temperature from about 20 to about 80° C.

The method may further comprise washing the purified graphite with DI water after step (b) and using the resulted wash solution to recover the acid filtrate.

The recovered acid filtrate is reused until the recovered acid filtrate comprises lower than 5% acid by weight. The method may further comprise bleeding a portion of the recovered acid filtrate that comprises lower than 5% acid by weight, and adding an amount of fresh acid to obtain a regenerated acid filtrate that comprises at least 5% acid by weight for reuse in step (b).

The objects and advantages of the invention will appear more fully from the following detailed description of the preferred embodiment of the invention made in conjunction with the accompanying drawings.

### BRIEF DESCRIPTION OF THE DRAWINGS

FIG. 1. Flow diagram of an exemplary process for graphite purification according to the present disclosure.

FIGS. 2A and 2B. Aluminum concentration (FIG. 2A) and sodium concentration (FIG. 2B) in the feed NaOH solution (a), filtrate (b), and wash solution resulted from washing the hydroxide-treated graphite (c). Aluminum concentration increases in each cycle, indicating successful purification of graphite and formation of NaAlO₂. Sodium concentration decreases in each cycle due to dilution.

### DETAILED DESCRIPTION

All references to singular characteristics or limitations of the disclosed method shall include the corresponding plural characteristic or limitation, and vice-versa, unless otherwise specified or clearly implied to the contrary by the context in which the reference is made. The indefinite articles “a” and “an” mean “one or more.”

The word “or” is defined inclusively and should be read as “and/or.”

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All combinations of method steps disclosed herein can be performed in any order, unless otherwise specified or clearly implied to the contrary by the context in which the referenced combination is made.

The method disclosed herein can comprise, consist of, or consist essentially of the essential elements and steps described herein, as well as any additional or optional ingredients, components, or limitations described herein or otherwise useful in the art. The disclosure provided herein suitably may be practiced in the absence of any element which is not specifically disclosed herein.

It is understood that the invention is not confined to the particular construction and arrangement of parts herein illustrated and described, but embraces such modified forms thereof as come within the scope of the claims.

Unless explicitly specified to the contrary, the term “solution” is used herein to refer to an aqueous solution, wherein “aqueous” refers to containing water as a solvent or medium.

As used herein, an “elevated temperature” refers to a temperature that is above the ambient or room temperature, and an “elevated pressure” refers to a pressure that is higher than the atmospheric pressure.

The present disclosure provides a process for purifying graphite to a purity of at least 99.9% while minimizing chemical waste. The purified graphite can be used in various applications that require high purity materials, including, but not limited to, lithium-ion batteries, fuel cells, alkaline batteries, and conductive additives. The graphite input source can be in various forms, including, but not limited to, natural flake graphite, spheronized flake, and recycled graphite from lithium-ion batteries.

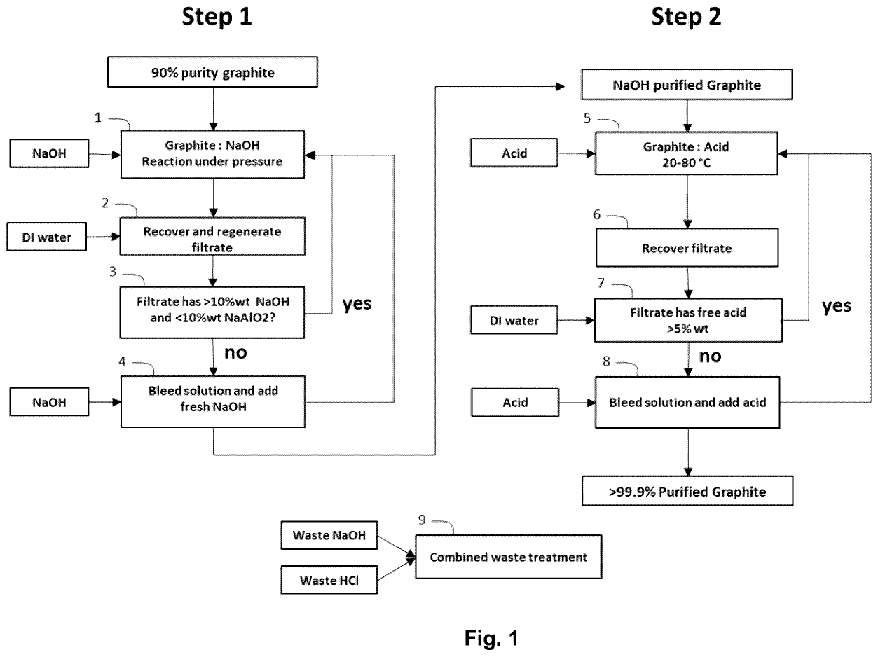

Disclosed herein is a two-step purification reaction that effectively purifies graphite with a wide range of impurities. FIG. 1 shows flow diagram of an exemplary process for graphite purification according to the present disclosure. As illustrated in FIG. 1, the first step involves a reaction with an aqueous alkaline solution, preferably a hydroxide solution under pressure (block 1). The alkaline solution is preferably a sodium hydroxide (NaOH) solution in water. Other suitable alkaline solutions include, but are not limited to, potassium hydroxide (KOH), lithium hydroxide (LiOH), and ammonium hydroxide (NH₄OH). The alkaline solution may contain one or more of these preferred hydroxide compounds. The reaction conditions are not particularly limited. Typically, if a hydroxide is used, the hydroxide solution has a concentration of about 10% to 50% by weight, and the reaction is conducted at a pressure of about 1-20 bar and a temperature of about 100-250° C. for a period of 1-12 hours or less. An exemplary preferred reaction condition includes treating the graphite feed using a 25% wt NaOH solution at a temperature of 200° C., a pressure of 10 bar for a duration of 4 hours.

This step is implemented to remove insoluble oxides such as silica (SiO₂), and alumina (Al₂O₃) often present in recycled graphite as well as natural graphite. The reaction mechanism is:

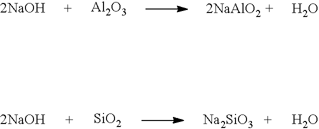

To minimize waste, the filtrate from the first reaction step (i.e., the solution after removing the graphite) is collected and replenished with DI water (block 2). This replenished filtrate is then used as an input solution for purification of another batch of graphite. The process is repeated till the solubility limit of either NaAlO₂ or Na₂SiO₃ is reached, or the kinetics of the reaction becomes prohibitively slow. For example, if the replenished filtrate comprises >10% wt NaOH or <10% wt NaAlO₂, it can be reused for purification of another batch of graphite (block 3). If the criteria are not met, a portion of the filtrate is bled off, and a minimal amount of fresh NaOH is added to the remaining filtrate to restore the concentration above >10% wt before reuse (block 4). The bled NaOH is then used to neutralize the acid waste generated from step 2 (block 9).

The second step involves a leaching reaction with an acid bath (block 5). The acid bath may contain one or more of the following acids: HCl, HNO₃, H₂SO₄ and HF. The preferred acid is HCl. The reaction condition of the acid bath is not particularly limited. Typically, the leaching reaction is conducted with an acid feed concentration of 7-37% by weight and a reaction temperature less than 80° C. (depending on feed concentration).

Similar to the first step, the acid filtrate is collected and replenished (if necessary) with DI water (block 6) for reuse. The process is then repeated till the free acid concentration drops and the kinetics of the leaching reaction becomes prohibitively slow. For example, if the replenished filtrate comprises >5% wt free acid, it can be reused (block 7). Otherwise, a portion of the acid filtrate is bled off, and a minimal amount of fresh acid is added to the remaining filtrate to regenerate the filtrate before reuse (block 8).

In an exemplary run of the method, graphite with purity of 97% was obtained from recycled battery materials. More specifically, the graphite used here is the by-product of extracting cathode material from shredded black mass. The graphite contains about 4000 ppm of Al in the form Al₂O₃ and 234 ppm of Si. Other impurities are also present at levels that do not meet the required standards. See Table 1, “Graphite Input”. The two-step process was conducted to purify the graphite.

To run the first reaction, 300 grams of graphite were mixed with 600 grams of aqueous solution of 25% NaOH by weight. The reaction took place at 200° C. and 10 bar pressure for 4 hours. The filtrate after removing the graphite powder had a weight of 205 grams, indicating that more than 50% of the water was lost due to evaporation. To recover the lost water, the graphite was rinsed with 398 grams of DI water and the rinsing solution was combined with the filtrate to regenerate the initial mass.

A full mass balance along with impurity profile at each step is shown in Table 1. The extraction efficiency of Al and Si using these reaction conditions were 99.77% and 95.94%, respectively. See Table 1, Cycle Number 1. The recycled filtrate solution was then used to purify two additional batches of low purity graphite. The extraction efficiencies of Al in the second and third cycles were slightly higher than in the first cycle, at 99.82% and 99.78%, respectively. The extraction efficiencies of Si decreased in the second and third cycles, with the values of 95.04% and 87.95%, respectively. See Table 1, Cycle Number 2 and Cycle Number 3.

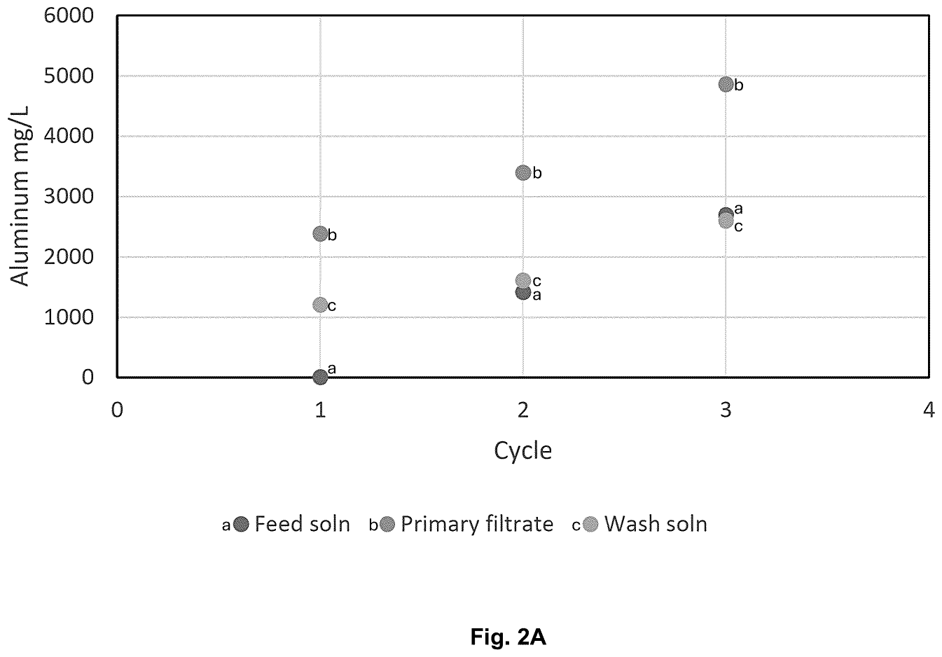

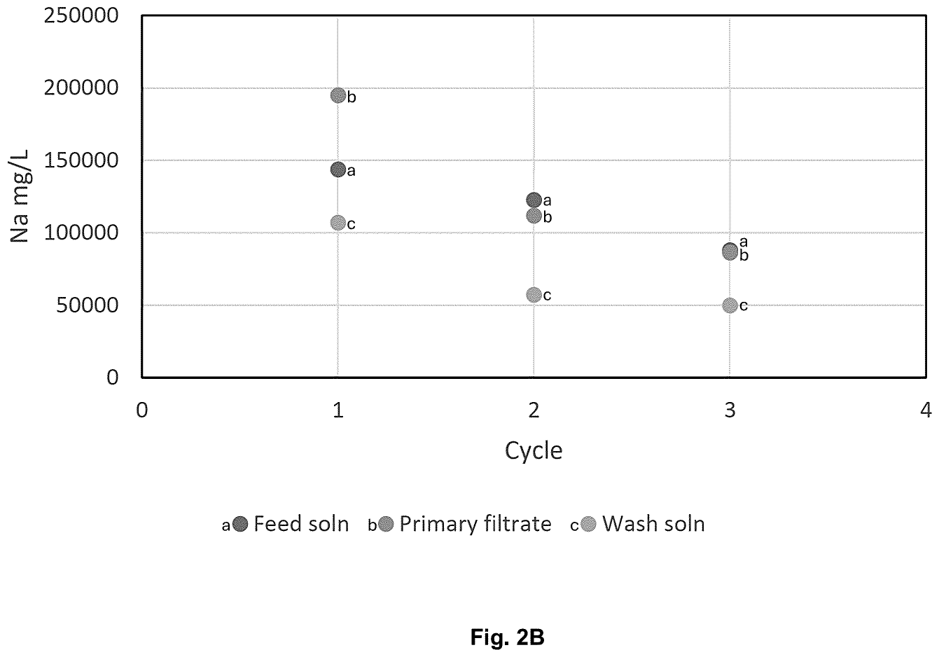

FIGS. 2A and 2B show aluminum concentration and sodium concentration in the feed NaOH solution, filtrate, and wash solution resulted from washing the NaOH purified graphite using DI water during each cycle. As shown in FIG. 2A, the aluminum concentration increases in all the solutions during each purification cycle, indicating successful purification of graphite and formation of NaAlO₂. As shown in FIG. 2B, the concentration of NaOH in the solutions decreased during each purification cycle due to dilution, but this decrease did not significantly impact the overall kinetics as indicated by the data shown in Table 1.

TABLE 1
Experimentally measured impurity levels of recycled graphite during different
steps of the purification reaction and different purification cycles.

| Cycle | | Impurities (mg/kg) | | | | | | | | | | |
|---|---|---|---|---|---|---|---|---|---|---|---|---|
| Number | Sample | Al | Ba | Ca | Co | Cu | Fe | Li | Mn | Na | Ni | Si |
| 1 | Graphite | 4022 | 33 | 18 | 152 | 13 | 28 | 9 | 131 | <10 | 225 | 234 |
| | Input | | | | | | | | | | | |
| 1 | Washed | 9 | 28.8 | 36.2 | 31 | <4 | 25.1 | <4 | 83 | 1413 | 181 | 9.5 |
| | Graphite | | | | | | | | | | | |
| | after 2 | | | | | | | | | | | |
| | steps | | | | | | | | | | | |
| 2 | Graphite | 4022 | 33 | 18 | 152 | 13 | 28 | 9 | 131 | <10 | 225 | 234 |
| | Input | | | | | | | | | | | |
| 2 | Washed | 7.3 | 1 | 24 | 2 | <2 | 5.8 | 2 | 8.6 | 58.3 | 7 | 11.6 |
| | Graphite | | | | | | | | | | | |
| | after 2 | | | | | | | | | | | |
| | steps | | | | | | | | | | | |
| 3 | Graphite | 4022 | 33 | 18 | 152 | 13 | 28 | 9 | 131 | <10 | 225 | 234 |
| | Input | | | | | | | | | | | |
| 3 | Washed | 8.7 | 1 | 21 | 2 | <2 | 6.3 | 2 | 9.7 | 49.8 | 6 | 28.2 |
| | Graphite | | | | | | | | | | | |
| | after 2 | | | | | | | | | | | |
| | steps | | | | | | | | | | | |

What is claimed is:

1. A method of producing purified graphite, the method comprising:
(a) treating a graphite-containing material with an alkaline solution at a temperature above 20° C. and pressure above ambient atmospheric pressure to yield an alkaline-treated graphite and an alkaline filtrate;
(b) treating the alkaline-treated graphite of step (a) with an acidic solution to yield a purified graphite and an acidic filtrate;
(c) recovering the alkaline filtrate of step (a) and using at least a portion of the recovered alkaline filtrate to form at least a portion of the alkaline solution used in step (a), and
(d) recovering the acidic filtrate of step (b) and using at least a portion of the recovered acidic filtrate to form at least a portion of the acidic solution used in step (b).

2. The method of claim 1, wherein the graphite material comprises natural graphite, spheronized graphite, or graphite from recycled battery materials.

3. The method of claim 1, wherein in step (a), the alkaline solution comprises one or more bases selected from the group consisting of NaOH, KOH, LiOH, and NH₄OH.

4. The method of claim 1, wherein in step (a), the alkaline solution is an aqueous solution of NaOH.

5. The method of claim 1, wherein in step (a), the temperature is from about 100° C. to about 250° C., and the pressure is from more than 1 bar to about 20 bar.

6. The method of claim 1, wherein in step (a), the temperature is about 200° C. and the pressure is about 10 bar.

7. The method of claim 1, further comprising washing the alkaline-treated graphite with deionized water after step (a) to yield a wash solution and using at least a portion of the wash solution at the alkaline solution of step (a).

8. The method of claim 1, wherein in step (c), at least a portion of the recovered alkaline filtrate is used to form at least a portion of the alkaline solution used in step (a) until the recovered alkaline filtrate comprises less than about 10 wt % alkali or greater than about 10 wt % NaAlO₂.

9. The method of claim 8, further comprising recovering at least a portion of the recovered alkaline filtrate that comprises less than 10 wt % alkali or greater than 10 wt % NaAlO₂ and adding an amount of fresh alkali to obtain a regenerated alkaline filtrate that comprises at least 10 wt % alkali and no more than 10 wt % NaAlO₂ and using at least a portion of the regenerated alkaline filtrate to make the alkaline solution of step (a).

10. The method of claim 1, wherein in step (b), the acidic solution comprises one or more acids selected from the group consisting of HCl, HNO₃, H₂SO₄, and HF.

11. The method of claim 1, wherein in step (b), the acidic solution is an aqueous solution of HCl.

12. The method of claim 1, wherein step (b) is conducted at a temperature from about 20° C. to about 80° C.

13. The method of claim 1, further comprising washing the purified graphite with deionized water after step (b) to yield a wash solution and using at least a portion of the wash solution as the acidic solution of step (b).

14. The method of claim 1, wherein in step (d) the recovered acidic filtrate is reused until the recovered acidic filtrate comprises less than 5 wt % acid.

15. The method of claim 14, further comprising recovering at least a portion of the recovered acidic filtrate that comprises less than 5 wt % acid by weight, and adding an amount of fresh acid to obtain a regenerated acidic filtrate that comprises at least 5 wt % acid, and using at least a portion of the regenerated acidic filtrate to make the acidic solution of step (b).

16. The method of claim 1, wherein the purified graphite of step (b) has a purity of at least 99.95%.

17. A method of producing purified graphite, the method comprising:
(a) treating a graphite-containing material with an aqueous hydroxide solution at a temperature above 20° C. and pressure above ambient atmospheric pressure to yield a hydroxide-treated graphite and a hydroxide filtrate;
(b) treating the hydroxide-treated graphite of step (a) with an acidic solution to yield a purified graphite and an acidic filtrate;
(c) recovering the hydroxide filtrate of step (a) and using at least a portion of the recovered hydroxide filtrate to form at least a portion of the aqueous hydroxide solution used in step (a), and
(d) recovering the acidic filtrate of step (b) and using at least a portion of the recovered acidic filtrate to form at least a portion of the acidic solution used in step (b).

18. The method of claim 17, wherein in step (a), the aqueous hydroxide solution comprises one or more hydroxides selected from the group consisting of NaOH, KOH, LiOH, and NH₄OH; and
in step (b), the acidic solution comprises one or more acids selected from the group consisting of HCl, HNO₃, H₂SO₄, and HF.

19. The method of claim 1, wherein in step (a) the aqueous hydroxide solution is an aqueous solution of NaOH; and in step (b), the acidic solution is an aqueous solution of HCl.

20. The method of claim 1, wherein step (b) is conducted at a temperature from about 20° C. to about 80° C.
